(19) United States
(12) Patent Application Publication
(10) Pub. No.: US 2003/0088807 A1
(43) Pub. Date: May 8, 2003

(54) Method and apparatus for facilitating checkpointing of an application through an interceptor library

(76) Inventors: Bernd J.W. Mathiske, Cupertino, CA (US); William F. Brodie-Tyrrell, Balhannah (AU)

Correspondence Address: PARK, VAUGHAN & FLEMING LLP, 508 SECOND STREET, SUITE 201, DAVIS, CA, 95616, US

(21) Appl. No.: 10/039,704

(22) Filed: Nov. 7, 2001

(51) Int. Cl. G06F 11/36; H04L 1/22

(52) U.S. Cl. 714/6

(57) ABSTRACT

One embodiment of the present invention provides a system for intercepting function calls and recording their parameters to facilitate creating a checkpoint for an application. The system operates by directing function calls to an interceptor library created for the purpose of intercepting the function calls. Functions within this interceptor library record the parameters of the function call, and then make the original call upon receiving the result of the function call. The interceptor library functions forward the results back to the application. In this way, the system records state information without modifying the application or the operating system.

### BACKGROUND

1. Field of the Invention

The present invention relates to operating systems for computers. More specifically, the present invention relates to a method and an apparatus for checkpointing an application within a computer system so that the application can later be returned to the same state, for example after a system failure, wherein the checkpointing is accomplished without modifying the application or the operating system.

2. Related Art

Computer systems often provide a checkpointing mechanism for fault-tolerance purposes. A checkpointing mechanism operates by periodically performing a checkpointing operation that stores a snapshot of the state of a running computer system to a checkpoint repository, such as a file. If the computer system subsequently fails, the computer system can rollback to a previous checkpoint by using information from the checkpoint file to recreate the state of the computer system at the time of the checkpoint. This allows the computer system to resume execution from the checkpoint, without having to redo the computational operations performed prior to the checkpoint.

In many cases, it is desirable to checkpoint a single application, and not the entire state of the computer system. One problem in doing so is that some of the state of the application resides within the kernel of the operating system. This means that merely copying the address space of the application is not sufficient to checkpoint the application. Information related to the application that resides within the kernel must somehow be recovered or restored.

In order to checkpoint an application, it is necessary to record state information from inside the kernel of an operating system, so that the processes can be accurately recreated during a checkpoint recovery operation. For example, a file reference may have to be recreated during a recovery operation because some aspects of program execution may depend upon having the proper file reference. Hence, if a file reference is not properly checkpointed, the restored application may behave differently than the original application.

Unfortunately, retrieving state information from inside the kernel and using this information to restore a process may require complicated additions and/or modifications to the kernel, and such kernel additions are typically very hard to debug and maintain.

Another option is to modify the application program to store the state information for checkpointing purposes. However, this involves a great deal of additional work for the application programmer.

What is needed is a method and an apparatus for intercepting function calls and recording their parameters to facilitate creating a checkpoint for the purpose of restoring an application without the above-described complications.

### SUMMARY

One embodiment of the present invention provides a system for intercepting function calls and recording their parameters to facilitate creating a checkpoint for an application. The system operates by directing function calls to an interceptor library created for the purpose of intercepting the function calls. Functions within this interceptor library record the parameters of the function call, and then make the original call upon receiving the result of the function call. The interceptor library functions forward the results back to the application. In this way, the system records state information without modifying the application or the operating system.

In one embodiment of the present invention, a checkpoint is created by stopping the application, retrieving the recorded parameters, saving the checkpoint data, with the recorded parameters, to secondary storage, and finally resuming the application.

In one embodiment of the present invention, the checkpoint data is used to restore the application to a previous state.

In one embodiment of the present invention, the checkpoint data is saved to persistent storage.

In one embodiment of the present invention, the checkpoint data is saved in a file system, or a database.

In one embodiment of the present invention, the function call is intercepted at an interceptor library that is created for the purpose of intercepting the function call.

In one embodiment of the present invention, the function call is made through the use of a function pointer.

In one embodiment of the present invention, results of the function call are recorded to facilitate creating a checkpoint that includes results of the function call.

In one embodiment of the present invention, the function calls include system calls and library calls.

In one embodiment of the present invention, the parameters include file paths, thread flags, and timer-thread relationships.

### BRIEF DESCRIPTION OF THE FIGURES

FIG. 1 illustrates a computer system containing a checkpointing process and a recovery process for an application in accordance with an embodiment of the present invention.

FIG. 2 is a flow chart illustrating the necessary steps to initialize the interceptor library in accordance with an embodiment of the present invention.

FIG. 3 is a flow chart illustrating the process of intercepting function calls to record their parameters in accordance with an embodiment of the present invention.

FIG. 4 is a flow chart illustrating the process of creating a checkpoint in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Interceptor, Checkpointing, and Recovery Processes

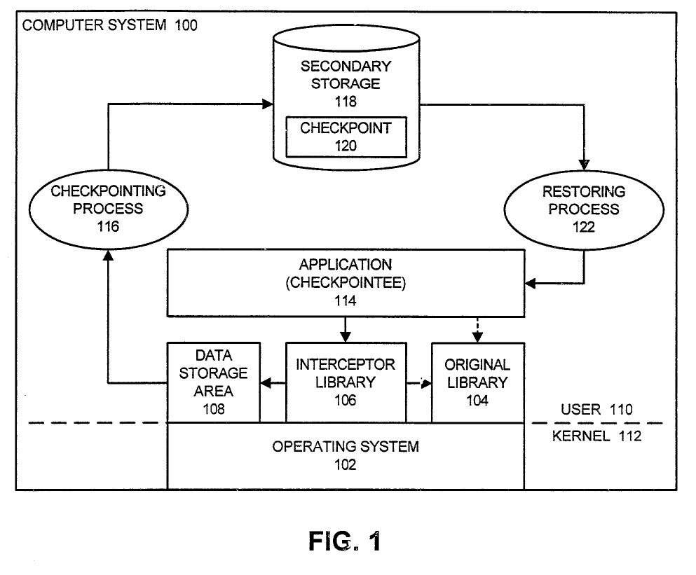

FIG. 1 illustrates a computer system 100 containing an application 114 comprising function calls that are intercepted by interceptor library 106 in accordance with an embodiment of the present invention. As illustrated in FIG. 1, computer system 100 includes an operating system 102, part of which exists within kernel space 112. Note that computer system 100 can generally include any type of computer system, including, but not limited to, a computer system based on a microprocessor, a mainframe computer, a digital signal processor, a portable computing device, a personal organizer, a device controller, and a computational engine within an appliance. Computer system 100 also contains an application 114, libraries 104 and 106, and data storage area 108 within user space 110. Traditionally, applications make system calls directly to library 104 which interfaces with operating system 102. Application 114, which is being checkpointed, has all of its function calls intercepted by pre-linking to interceptor library 106 created for the purpose of intercepting the function calls.

Note that pre-linking refers to the process of dynamically linking a library to a program during a run-time invocation. Note that this pre-linking is performed on a program that has already been compiled and linked into an executable file. In this way, the checkpointing process of the present invention can be applied to any executable code, without having to modify or re-link the executable code.

Functions within interceptor library 106 record the parameters of the function call, saves the parameters to data storage area 108, and then makes the original function call to the original library 104. Upon completion of the function call, library 106 passes the results of the function back to application 114.

Computer system 100 also contains checkpointing process 116 which retrieves data from data storage area 108 and other system information and creates checkpoint 120 which it saves within secondary storage 118. Secondary storage 118 is a storage device that can include any type of non-volatile storage device that can be coupled to a computer system. This includes, but is not limited to, magnetic, optical, and magneto-optical storage devices, as well as storage devices based on flash memory and/or battery-backed up memory.

Computer system 100 also contains restoring process 122 which uses the data saved in checkpoint 120 to restore the state of application 114 and operating system 102 to the same state as when checkpoint 120 was created.

Interceptor Initialization

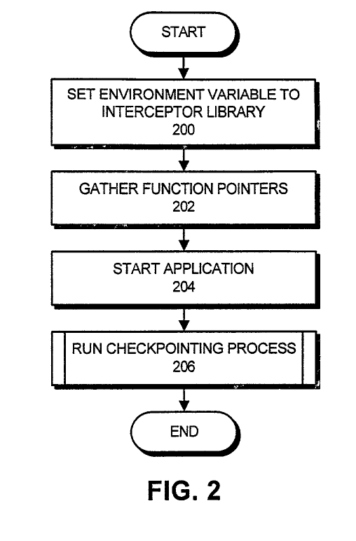

FIG. 2 is a flow chart illustrating steps to initialize interceptor library 106 in accordance with an embodiment of the present invention. The system first sets an environment variable to interceptor library 106 (step 200). This directs all function calls to interceptor library 106 rather than the original library 104. Next, the system gathers the function pointers to functions within original library 104 that correspond to functions within interceptor library 106 (step 202) so it knows where to forward the function calls from interceptor library 106. Then, the system starts the application 114 (step 204); and finally, runs the checkpointing process 116 (step 206).

Interceptor Process

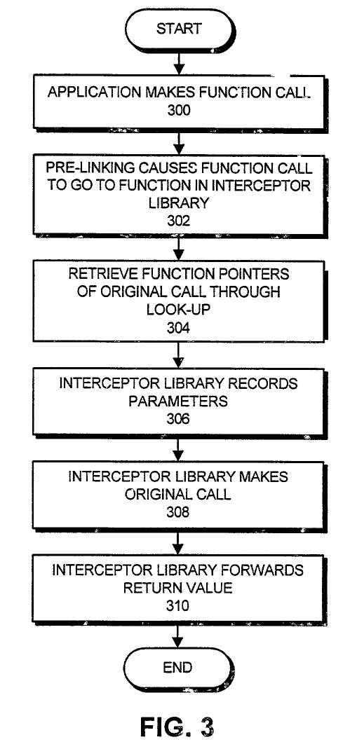

FIG. 3 is a flow chart illustrating the process of intercepting function calls to record their parameters in accordance with an embodiment of the present invention. Application 114 starts by making a function call (step 300). Pre-linking causes this function call to be directed to interceptor library 106 rather then to original library 104 (step 302). If this is the first time this particular function call has been made, interceptor library 106 dynamically retrieves the function pointers of the original call through a look-up (step 304). Next, interceptor library 106 records the parameters of the function call to data storage area 108 within semiconductor memory (step 306) and then makes the original function call (step 308). Finally, interceptor library 106 forwards the return values of the function call back to application 114 (step 310).

Checkpoint Creation

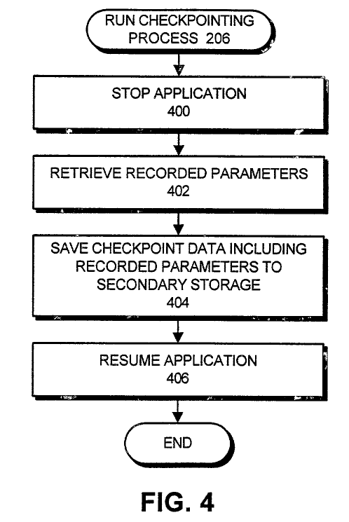

FIG. 4 is a flow chart illustrating the process of creating a checkpoint in accordance with an embodiment of the present invention. The checkpointing process starts by stopping application 114 (step 400). This avoids problems that might arise if, for instance, a checkpoint is created while the application is in the middle of a transaction. In this case, there is no way to roll back to the beginning of the transaction or to restore to the state after the transaction is completed because the checkpoint is created while the application is an inconsistent state. Next, checkpointing process 116 retrieves the recorded parameters from data 108 (step 402) and saves all checkpoint data including the recorded parameters to checkpoint 120 within secondary storage 118 (step 404). Finally, the checkpointing process resumes application 114 (step 406).

Note that by storing parameters of function calls during the checkpointing process, it is possible to reconstruct some of the application state stored within kernel 112. For example, by storing a file name during a file open system call, it is possible to determine which file the application was accessing.

Note that it is possible to also store information on thread flags and timer-thread relationships in this way.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for checkpointing an application, comprising:
pre-linking an interceptor library into the application during a run-time invocation of the application, wherein the run-time invocation occurs after the application has been complied and linked;
intercepting a function call produced by the application at the interceptor library;
recording parameters of the function call to create a checkpoint that includes information about the function call parameters;
making the function call;
receiving results of the function call; and
forwarding results of the function call back to the application.

2. The method of claim 1, further comprising creating a checkpoint by:
stopping the application;
retrieving the recorded parameters;
saving the checkpoint data, including the recorded parameters, to secondary storage; and
resuming the application.

3. The method of claim 2, further comprising using the checkpoint to restore the application.

4. The method of claim 2, wherein saving the checkpoint data to secondary storage involves saving the checkpoint data to a persistent storage.

5. The method of claim 2, wherein saving the checkpoint data to secondary storage involves saving the checkpoint data in a file system, or a database.

6. The method of claim 1, wherein making the function call involves referencing the function through a function pointer.

7. The method of claim 1, further comprising recording the results of the function call to facilitate creating a checkpoint that includes information about the results of the function call.

8. The method of claim 1, wherein the function calls can include system calls or lib calls.

9. The method of claim 1, wherein the parameters can include:
file paths;
thread flags; and
timer-thread relationships.

10. A computer-readable storage medium storing instructions that when executed by a computer cause the computer to perform a method for checkpointing an application, the method comprising:
pre-linking an interceptor library into the application during a run-time invocation of the application, wherein the run-time invocation occurs after the application has been complied and linked;
intercepting a function call produced by the application at the interceptor library;
recording parameters of the function call to create a checkpoint that includes information about the function call parameters;
making the function call;
receiving results of the function call; and
forwarding results of the function call back to the application.

11. The computer-readable storage medium of claim 10, further comprising creating a checkpoint by:
stopping the application;
retrieving the recorded parameters;
saving the checkpoint data, including the recorded parameters, to secondary storage; and
resuming the application.

12. The computer-readable storage medium of claim 11, further comprising using the checkpoint to restore the application.

13. The computer-readable storage medium of claim 11, wherein saving the checkpoint data to secondary storage involves saving the checkpoint data to a persistent storage.

14. The computer-readable storage medium of claim 12, wherein saving the checkpoint data to secondary storage involves saving the checkpoint data in a file system, or a database.

15. The computer-readable storage medium of claim 10, wherein making the function call involves referencing the function through a function pointer.

16. The computer-readable storage medium of claim 10, wherein the method further comprises recording the results of the function call to facilitate creating a checkpoint that includes information about the results of the function call.

17. The computer-readable storage medium of claim 10, wherein the function calls can include system calls or lib calls.

18. The computer-readable storage medium of claim 10, wherein the parameters can include:
file paths;
thread flags; and
timer-thread relationships.

19. An apparatus that checkpoints an application, comprising:
a pre-linking mechanism that is configured to pre-link an interceptor library into the application during a run-time invocation of the application, wherein the run-time invocation occurs after the application has been complied and linked;
an intercepting mechanism within the interceptor library that is configured to intercept a function call produced by the application;
a recording mechanism that is configured to record parameters of the function call to facilitate creating a checkpoint that includes information about the function call parameters;
a calling mechanism that is configured to make the function call;
a receiving mechanism that is configured to receive results of the function call; and
a forwarding mechanism that is configured to forward results of the function call back to the application.

20. The apparatus of claim 19, further comprising a checkpoint creation mechanism that is configured to:
stop the application;
retrieve the recorded parameters;
save the checkpoint data, including the recorded parameters, to secondary storage; and to
resume the application.

21. The apparatus of claim 20, further comprising a restoration mechanism that is configured to use the checkpoint data to restore the application to the checkpointed state.

22. The apparatus of claim 20, wherein the checkpoint creation mechanism is configured to save checkpoint data to a persistent storage.

23. The apparatus of claim 20, wherein the checkpoint creation mechanism is configured to save the checkpoint data in a file system, or a database.

24. The apparatus of claim 19, wherein the calling mechanism is configured to make the function call by referencing the function through a function pointer.

25. The apparatus of claim 19, further comprising a recording mechanism that is configured to record the results of the function call to facilitate creating a checkpoint that includes information about the results of the function call.

26. The apparatus of claim 19, wherein the function calls can include system calls or lib calls.

27. The apparatus of claim 19, wherein the parameters can include:
file paths;
thread flags; and
timer-thread relationships.
